(19) United States
(12) Patent Application Publication
(10) Pub. No.: US 2025/0091413 A1
(43) Pub. Date: Mar. 20, 2025

(54) SHEET METAL PART FOR A GLASS ELEMENT OF A VEHICLE ROOF, DEVICE FOR PRODUCING A GLASS ELEMENT FOR A VEHICLE ROOF, AND VEHICLE ROOF

(71) Applicant: Webasto SE, Stockdorf (DE)

(72) Inventor: Martin SEEBAß, Stockdorf (DE)

(21) Appl. No.: 18/818,100

(22) Filed: Aug. 28, 2024

(30) Foreign Application Priority Data
Sep. 15, 2023 (DE) 10 2023 124 977.0

(51) Int. Cl. B60J 1/00; B21D 53/88; B62D 25/06

(52) U.S. Cl. CPC B60J 1/005; B21D 53/88; B62D 25/06

(57) ABSTRACT

A sheet metal part for a glass element of a vehicle roof, wherein the sheet metal part is designed as a closed sheet metal frame, which is formed by four elongate frame portions, of which two frame portions are arranged opposite one another in each case, the frame portions have two first slots and one second slot, and the first slots are designed for positioning the sheet metal part in a moulding tool with respect to a first direction, in particular an X direction, and the second slot is designed for positioning the sheet metal part in the moulding tool with respect to a second direction, in particular a Y direction, which runs perpendicular to the first direction, characterized in that one frame portion has a further second slot. The disclosure also relates to a device and to a vehicle roof.

### CROSS-REFERENCE TO RELATED APPLICATION(S)

This application claims the benefit of German patent application no. 10 2023 124 977.0 filed on Sep. 15, 2023, which is incorporated herein by reference in its entirety.

### TECHNICAL FIELD

This disclosure relates generally to a sheet metal part for a glass element of a vehicle roof, to a device for producing a glass element for a vehicle roof, and to a vehicle roof.

### BACKGROUND

Glass elements for motor vehicles are generally known from the prior art. Glass elements are typically installed in a vehicle in two constellations, namely as movable glass elements for opening and closing a vehicle roof (keyword: sliding roof) or as so called fixed glass elements that are permanently installed in the vehicle roof (for example, so called panoramic roofs). For installation in the vehicle roof, the glass element typically has one or more foam surrounds, which are arranged on an edge of the glass element, for example. These can be used to fixedly connect one or more other components, such as a sheet metal part, to the glass element. Such a sheet metal part can be provided as a stiffener for the glass element and/or also for mechanical fixed coupling with the motor vehicle, for example, depending on the intended use, with a sliding roof mechanism, the bodywork or a roof frame of the motor vehicle.

A special tool required for the production of the glass element is a so called moulding or foaming tool and usually has two tool halves, which are matched to each other as upper and lower parts and enable the formation of the aforementioned foam surrounds. According to a typical production process, one or more glass panes and other components such as the sheet metal part are inserted into the moulding tool before the foaming material is introduced into the moulding tool after the two tool halves are closed and fixedly joins all of the inserted components together to produce the glass element.

The production of a foam surround is described, for example, in the European patent specification EP 0355209 B1.

### SUMMARY

One problem addressed by the invention is to specify a concept that enables particularly reliable and precise production of the glass element.

According to a first aspect, a sheet metal part for a glass element of a vehicle roof is disclosed. The sheet metal part is formed as a closed sheet metal frame, which is formed by four elongate frame portions, of which two frame portions are arranged opposite one another in each case. In other words, the sheet metal frame has frame portions arranged opposite each other in pairs. The frame portions have two first slots and one second slot. The three slots can be provided on one frame portion or distributed over two or three frame portions. The first slots are designed for positioning the sheet metal part in a moulding tool with respect to a first direction, in particular an X direction, and the second slot is designed for positioning the sheet metal part in the moulding tool with respect to a second direction, in particular a Y direction, which runs perpendicular to the first direction. One of the frame portions has a further second slot.

The sheet metal part described is intended for the production of a glass element, wherein the sheet metal part becomes an integral part of the glass element by means of one or more foam surrounds. During production, the sheet metal part is inserted into a special moulding tool together with other components such as one or more panes. After closing the moulding tool, one or more cavities are formed in the moulding tool, which are then filled with foaming material. After the foaming material has hardened, one or more foam surrounds are formed that fixedly connect the components inserted into the moulding tool, such as the sheet metal part. This means that the sheet metal part in particular is fixedly connected to the one or more panes. The sheet metal part is made of a metal material, for example steel or aluminium. The disclosure is not limited to a sheet metal part, but instead of the sheet metal part, a frame part can be provided or used which is formed as a closed frame and is not made of a metal material, for example, such as a plastics or a fibre composite material.

Such a foam surround is typically formed at the edge of the glass element and surrounds the glass element at the edge. Here and in the following, the edge of the glass element refers to lateral boundaries of the glass element that extend substantially in a horizontal plane parallel to a vehicle roof of the motor vehicle in the operationally installed state. A foam surround is, for example, a polyurethane foam surround.

The sheet metal part must be securely positioned when it is inserted into the moulding tool, in particular so that specified tolerances are adhered to and a particularly precise production of the glass element is achieved. For this purpose, positioning pins are provided in the moulding tool, each of which engages in a corresponding first or second slot in order to form a 3 point bearing. Contrary to typical mechanical practice, the invention now provides for a fourth slot instead of the 3 point bearing by means of three slots, whereby a mechanical over determination is deliberately accepted. This over determination ensures that the sheet metal part is nevertheless securely positioned in the moulding tool despite its not particularly torsion resistant and/or bending resistant nature. Advantageously, the invention prevents rotation of the sheet metal part about a positioning pin, as would be possible with a 3 point bearing depending on the position of the slots. Equally advantageously, trapezoidal twisting of the sheet metal part can be prevented in comparison to a 3 point bearing. Such a twisting and/or rotation would, for example, result in receiving tabs or retaining tabs of the sheet metal part for connection to the motor vehicle being unstable in their positions in the moulding tool and often lying outside the permissible tolerances after the glass element has been manufactured. The latter is effectively avoided by the invention.

Here and in the following, a Cartesian coordinate system is used as the basis for directional information. The sheet metal frame has a predetermined length along the X direction and a predetermined width along the Y direction. The X direction also corresponds to the longitudinal direction of the vehicle if the sheet metal part is installed in a motor vehicle as intended, i.e. as an integral part of the glass element. Accordingly, an X slot is designed in such a way that movement in the X direction is prevented, but a degree of freedom in the Y direction is permitted. Similarly, a Y slot prevents movement in the Y direction but allows a degree of freedom in the X direction.

The first and second directions are oriented perpendicular to each other, i.e. 90° to each other. Small deviations of about +/5% from 90° are also included.

The frame portions can also be referred to as frame legs. The sheet metal frame is closed, as the frame portions are connected to each other at their ends. Preferably, the sheet metal frame is formed in one piece; the sheet metal frame can also be formed from several separate, fixedly connected elements, such as the four frame portions. The four frame portions are, for example, two opposing transverse frame portions and two opposing longitudinal frame portions. For example, the longitudinal frame portions extend along the X direction and the transverse frame portions along the Y direction.

The first direction is preferably the X direction and the second direction is preferably the Y direction. The first slots are preferably X slots and the second slots are preferably Y slots. An X slot is therefore designed for positioning the sheet metal part in the moulding tool with respect to the X direction and the Y slot is therefore designed for positioning the sheet metal part in the moulding tool with respect to the Y direction. The first slots and the second slots can also be designed differently and thus act in other directions, wherein it must be ensured that their directions of action are oriented at 90° to each other. For example, the first slots are Y slots and the second slots are X slots.

According to one embodiment, a first frame portion of the four frame portions has the first slots and the one second slot, wherein a second frame portion has the other second slot. This contributes to a stable positioning of the sheet metal part in the moulding tool.

According to one embodiment, the second frame portion is opposite the first frame portion. This contributes to a particularly stable positioning of the sheet metal part in the moulding tool, especially if the first frame portion has the aforementioned three slots and the second frame portion has the additional second slot.

According to one embodiment, the second frame portion is oriented perpendicular to the first frame portion. The second frame portion is thus directly adjacent to the first frame portion. In other words, the second frame portion is a side part with respect to the first frame portion. This contributes to the aforementioned advantages and functions.

According to one embodiment, the second slot of the first frame portion is arranged between the two first slots with respect to a longitudinal direction of the first frame portion. This contributes to secure positioning of the sheet metal part in the moulding tool.

According to one embodiment, the further second slot of the second frame portion is arranged in the region of a longitudinal end of the second frame portion. This contributes to the aforementioned advantages and functions. In the region of a longitudinal end means an end portion of the second frame portion with respect to a longitudinal direction of the second frame portion. For example, the region comprises 20% of the total length of the second frame portion starting from an outer end of the second frame portion towards its centre.

According to a second aspect, a sheet metal part for a glass element of a vehicle roof is disclosed analogously to the above. The sheet metal part is formed analogously to above. In contrast to the sheet metal part according to the first aspect, no fourth slot (further second slot) is provided, but one of the frame portions has at least one spacer. The at least one spacer serves to position the sheet metal part in the moulding tool with respect to the second direction.

The above explanations apply analogously and the developments, if appropriate, are also applicable analogously to the sheet metal part according to the second aspect. The sheet metal part according to the second aspect enables the above mentioned advantages and functions.

The at least one spacer is attached to the sheet metal part as a separate element from the sheet metal part. As soon as the sheet metal part is inserted into the moulding tool, the at least one spacer comes into contact with a side wall of the moulding tool, i.e. with a vertically extending side wall of the lower or upper tool half. As with a second slot, the positioning of the sheet metal part with respect to the second direction (such as the Y direction) is thus achieved or improved by means of the at least one spacer. The at least one spacer can also be referred to as a positioning piece, spacer or stop block. The at least one spacer is fixedly or detachably arranged on the sheet metal part.

Alternatively, the at least one spacer can be arranged on the moulding tool, fixedly or detachably, for example on the lower or upper tool half.

It should be noted that more than one spacer may also be provided on one or more of the frame portions or the moulding tool. The above and following explanations with regard to the at least one spacer also apply analogously to several such spacers.

According to one embodiment, the at least one spacer is made of a plastics material, in particular an elastomer. This contributes to gentle contact with the moulding tool and allows the sheet metal part to be positioned precisely. The spacer can also be made of aluminium, steel, stainless steel or polished stainless steel. Optionally, the spacer has a coating, in particular to prevent scratches on the sheet metal part.

According to one embodiment, a first frame portion has two first slots, such as X slots, and a second slot, such as Y slots, wherein the at least one spacer is arranged on a second frame portion which is oriented perpendicular to the first frame portion. This contributes to the aforementioned advantages and functions.

According to one embodiment, the at least one spacer is arranged on a retaining bracket of a frame portion. Such a retaining bracket, also known as a retaining angle bracket, extends vertically, i.e. in the Z direction, from the corresponding frame portion and thus provides sufficient surface area for attaching the spacer.

At this point, it should be noted that embodiments are also disclosed which combine the features of the sheet metal parts according to the first and second aspects. Thus, a sheet metal part analogous to the above is also included, which has both a further second slot and at least one spacer. All of the embodiments described above can be applied analogously and the aforementioned advantages and functions are equally possible. This also applies to the other aspects described below.

According to a third aspect, a device for producing a glass element for a vehicle roof is disclosed. The device has a moulding tool with a lower and an upper tool half. The lower tool half is designed to form fittingly receive a sheet metal part according to one of the embodiments described above. The lower tool half has three positioning pins which are arranged in such a way that they engage form fittingly in the corresponding first slots and the second slot of the received sheet metal part. This already achieves centring or positioning. The device also has one or more of the following features:
the lower tool half has a further positioning pin for engagement in the further second slot; and/or
a side wall of the lower or upper tool half is in direct contact with at least one spacer arranged on the sheet metal part; and/or
the lower or upper tool half has at least one spacer for direct contact with the sheet metal part.

The device enables the aforementioned advantages and functions. In particular, the sheet metal part is centred or positioned in the forming tool with mechanical over determination. The above comments on embodiments and features apply analogously, in particular with regard to the slots, the directions and the spacer. It should be mentioned that one or more spacers can be arranged not only on the sheet metal part, but alternatively or additionally on the moulding tool.

It should be noted at this juncture that in all embodiments described in this disclosure, the arrangement of positioning pins and slots may be interchanged. For example, the moulding tool, such as the lower half of the tool, may have slots and the sheet metal part may have corresponding positioning pins.

The lower and/or upper tool half have a shaping region, such as a recess, for defining the cavity and for forming the foam surround of the glass element to be produced. The sheet metal part, for example, is at least partially inserted or arranged in this recess.

For example, the device has suitable means for supporting the moulding tool and moving the tool halves relative to each other, for example for opening or closing. The device also comprises means for introducing the foaming material. One or more slides can also be provided for the moulding tool in order to enable certain geometries of the foam surround.

It should be noted that the term “tool half” does not represent a geometrically exact half of the moulding tool. Rather, it refers to two tool parts of the moulding tool that together form a whole. In other words, it is, for example, an upper and lower mould.

According to a fourth aspect, a vehicle roof of a motor vehicle is disclosed. The vehicle roof has a glass element, wherein the glass element has a sheet metal part according to one of the previously described embodiments. Accordingly, the glass element is fixedly connected to the vehicle roof as described above. The vehicle roof in essence enables the aforementioned advantages and functions. The above comments on embodiments apply analogously.

According to a fifth aspect, a method for producing a glass element for a vehicle roof of a motor vehicle is disclosed. The method comprises the steps of:
providing a lower tool half and an upper tool half of a moulding tool,
arranging a sheet metal part according to one of the previously described embodiments at a predetermined position in the lower tool half,
inserting a pane at least partially into the lower half of the tool,
closing the two tool halves in such a way that the two tool halves together with the pane form one or more cavities along one edge of the pane, in which the sheet metal part is at least partially arranged,
introducing foaming material into the cavity in such a way that one or more foam surrounds are formed around the edge of the pane, into which the sheet metal part is at least partially foamed, so that the sheet metal part is coupled to the pane form fittingly and/or in an integrally bonded manner.

The method substantially enables the aforementioned advantages and functions. The defined positioning of the sheet metal part in the lower tool half is achieved by form fit with the described slots and/or the spacer. The above comments on embodiments apply analogously.

Further advantages, features and developments can be found in the following exemplary embodiments explained in conjunction with the figures. Like, similar or similarly acting elements are provided with the same reference signs in the figures.

### BRIEF DESCRIPTION OF DRAWINGS

FIG. 1 shows a perspective view of a motor vehicle with a vehicle roof and a glass element,

FIG. 2 shows a schematic, perspective view of a device for producing a glass element,

FIG. 3 shows a schematic detailed view of the device according to FIG. 2,

FIGS. 4 and 5 show two schematic detailed views of a slot in a sheet metal part for the glass element,

FIG. 6 shows a schematic cross sectional view of the device according to FIG. 2 during the production of a foam surround,

FIG. 7 shows schematic illustrations of torsion and twisting of the sheet metal part,

FIG. 8 shows a schematic perspective view of a sheet metal part according to an exemplary embodiment of the invention, and

FIGS. 9 and 10 show schematic views of a sheet metal part according to a further exemplary embodiment of the invention.

### DETAILED DESCRIPTION

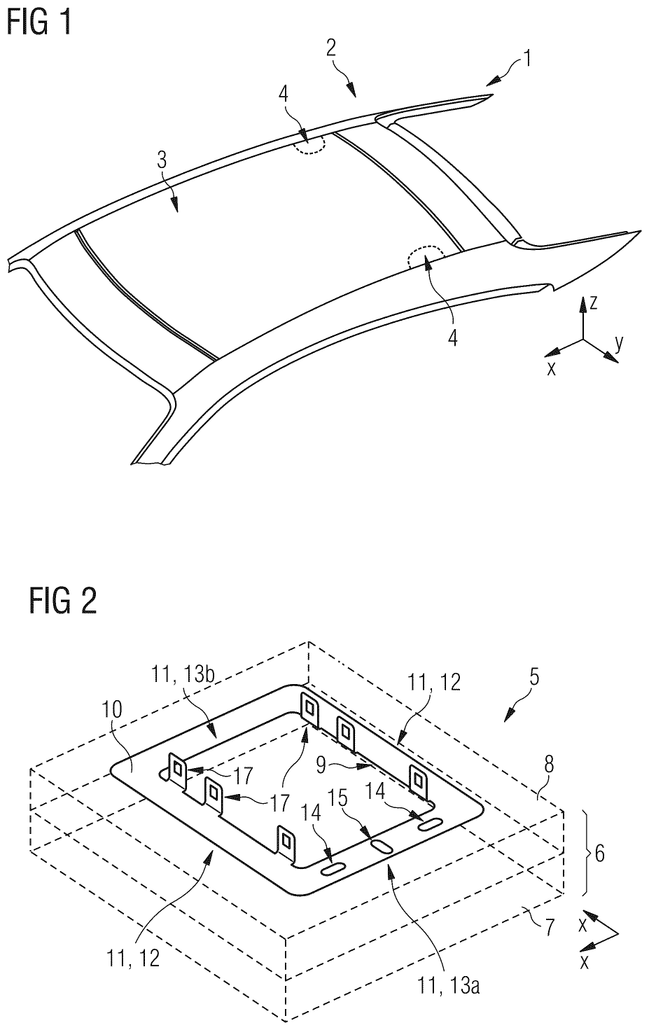

FIG. 1 shows a schematic perspective view of a motor vehicle 1 with a vehicle roof 2 that has a glass element 3 (also known as a cover). In the exemplary embodiment, the glass element 3 is a glass element that is immovable relative to the vehicle roof 2 and is also referred to as a fixed glass element or fixed glass module (FTM: Fixed Typed Module). Alternatively, the glass element 3 is movable relative to the vehicle roof 2 in order to optionally open, partially open, or close an opening in the vehicle roof 2. The glass element 3 has fastening regions 4, two of which are shown as examples in FIG. 1. In the fastening regions 4, the glass element 3 is fixedly mechanically connected, for example fixedly screwed, to the vehicle roof 2, for example to the body or roof frame elements. In the case of a movable element, the glass element 3 is coupled, for example, to a deployment and displacement mechanism for controlling the movement of the glass element 3. For the respective connection, the glass element 3 has, for example, retaining brackets (also known as retaining angle brackets or retaining angles), which are an integral part of the glass element 3.

As explained at the outset, the glass element 3 is typically made of several components that are fixedly connected to each other. In particular, the glass element 3 comprises a glass pane, a sheet metal frame and a foam surround, in particular a so called edge foam surround. During production, the sheet metal frame, which typically has the aforementioned retaining tabs, is fixedly connected to the glass pane by means of the foam surround. It should be noted that instead of one glass pane, several panes or a so called pane assembly can also be provided.

The coordinate systems shown in the figures apply to directions. The X direction corresponds to the longitudinal direction of the vehicle, the Y direction to the transverse direction of the vehicle, and the Z direction to the height direction (vertical direction or direction of gravity).

FIG. 2 schematically shows a device 5 for producing such a glass element 3. The device 5 comprises a moulding tool 6, also referred to as a foaming tool. The moulding tool 6 comprises two tool halves: a lower tool half 7 and an upper tool half 8 (schematically indicated by dashed lines).

A sheet metal part 9, which is designed as a closed sheet metal frame 10, is inserted into the lower tool half 7. The sheet metal part 9 becomes an integral part of the glass element 3 to be produced by means of an edge foam surround. The sheet metal frame 10 is formed by four elongate frame portions 11, which are positioned opposite each other in pairs. The sheet metal frame 10 therefore has two longitudinal frame portions 12 and two transverse frame portions 13. The frame portions 11 are arranged at right angles to each other, for example, but this does not necessarily have to be the case. In addition, the sheet metal part 9 is formed in one piece, although this does not necessarily have to be the case.

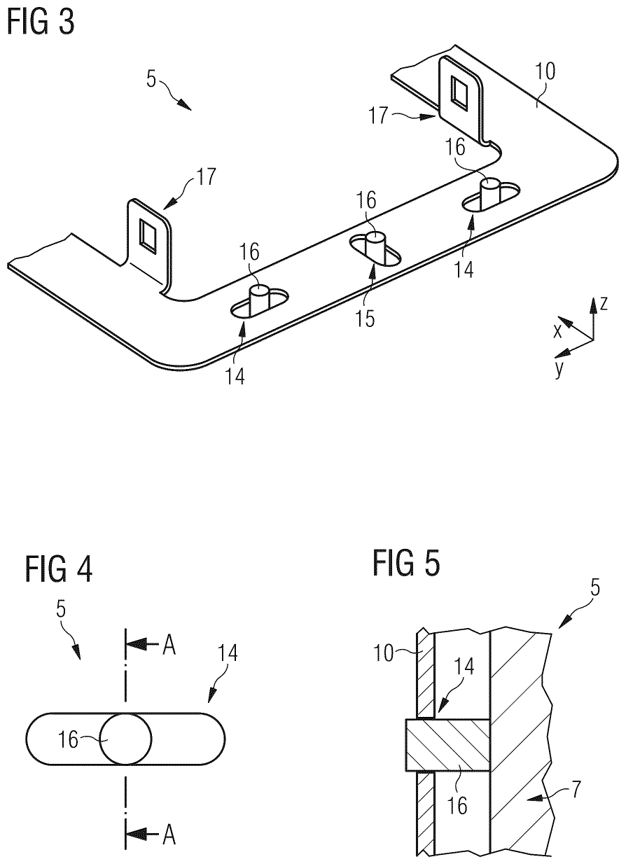

One of the frame portions 11 (first frame portion), a first transverse frame portion 13, has three slots, namely two X slots 14 (as first slots) and a Y slot 15 (as second slot), as described at the outset. The Y slot 15 is arranged along the longitudinal direction of the first transverse frame portion 13 between the two X slots 14. The slots 14 and 15 are coordinated with positioning pins 16 (see FIG. 3) of the lower tool half 7, wherein one positioning pin engages form fittingly in a corresponding slot and blocks the sheet metal part 9 in one of the two directions X and Y (as first and second directions respectively), while a degree of freedom exists in the respective other direction.

FIG. 3 shows an example of a portion of the device 5, in which the three slots 14 and 15 can be recognized. The positioning pins 16, which engage form fittingly in the slots 14 and 15, are also shown.

FIG. 4 shows a schematic top view of an X slot 14 with an engaging positioning pin 16 and FIG. 5 shows a sectional view A A of FIG. 4.

The sheet metal frame 10 also has several retaining tabs 17 (see FIGS. 2 and 3).

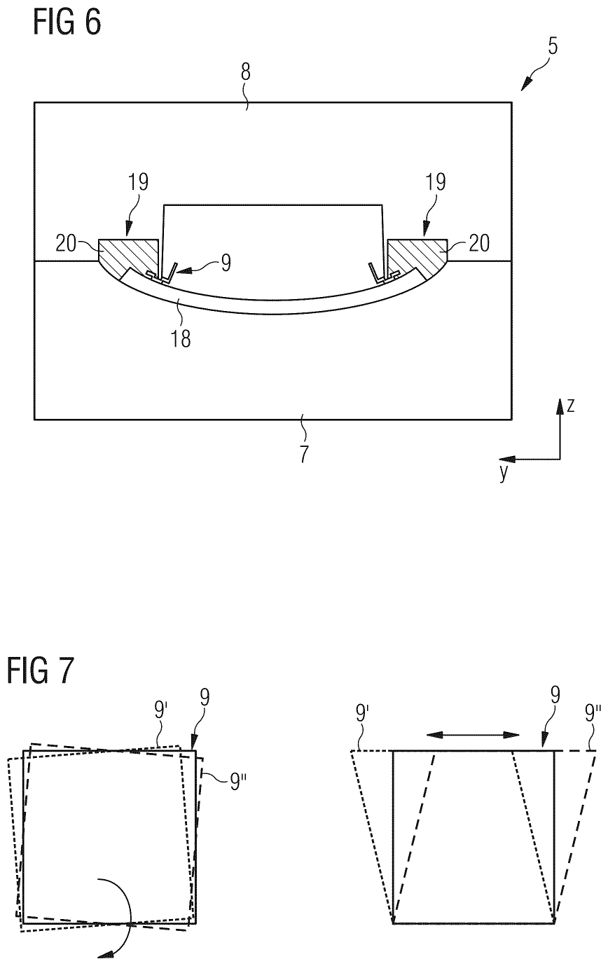

FIG. 6 shows a schematic cross sectional view of the device 5 as shown in FIG. 2. In addition to the sheet metal part 9, a glass pane 18 is also inserted into the mould 6. When the two tool halves 7 and 8 are closed (as shown in FIGS. 2 and 6), they form a cavity 19. Foaming material is introduced into the cavity 19 in a production step, such as a polyurethane foam, which hardens to form a foam surround 20. In the example, the cavity 19 is formed peripherally at the edge of the glass pane 18, so that only the foam surround 20 is formed, which is therefore a peripheral edge foam surround. After curing and removal, the glass element 3 is produced, which can of course be further processed if necessary.

To position the sheet metal part 9 in the lower tool half 7, the three slots 14 and 15 are provided as described, so that a mechanically determined 3 point bearing is provided.

It can be seen that the sheet metal part 9, in particular due to the frame geometry and the thin sheet metal material (sheet thickness for example 2.0 mm, 1.0 mm to 1.2 mm or less than 1.0 mm), tends to twist or turn in the inserted state, as schematically indicated in FIG. 7, which shows a twisting on the left, in particular about the positioning pin of the Y slot 15, and a trapezoidal twisting on the right (see positions 9′ and 9″ of the sheet metal part 9, which are shown exaggerated accordingly and represent deviations from the ideal position in the moulding tool 6).

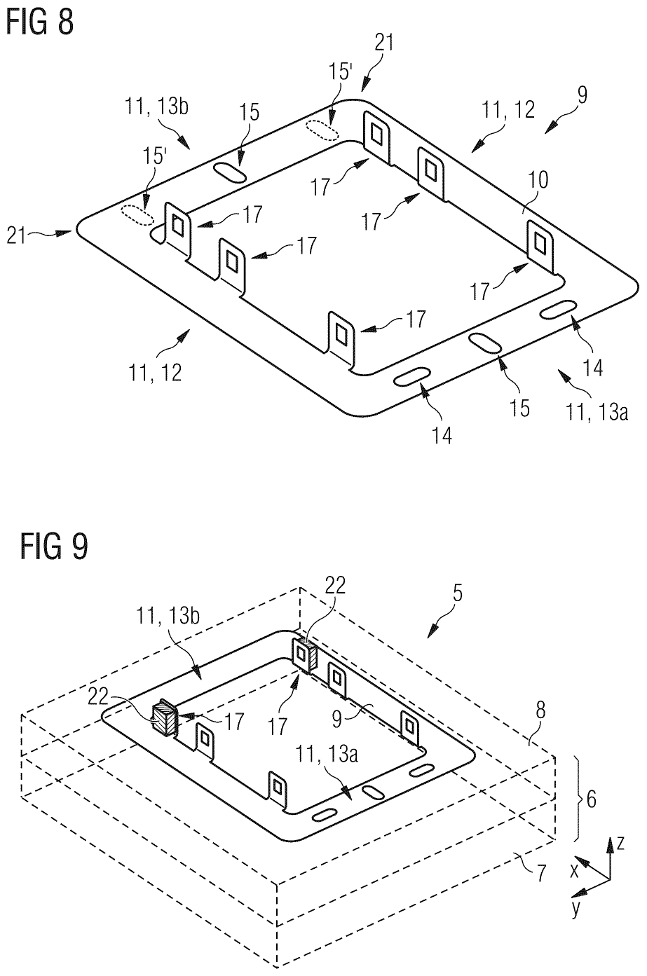

FIG. 8 shows a sheet metal part 9 according to an exemplary embodiment of the invention. This corresponds substantially to the sheet metal part 9 described above, wherein, by contrast, a further frame portion 11 has an additional slot. Specifically, the transverse frame portion 13b opposite a transverse frame portion 13a has a Y slot 15, in which a corresponding further positioning pin of the lower tool half 7 engages. When the sheet metal frame 10 is inserted into the lower tool half 7, there is therefore a mechanical over determination which, contrary to the usual assumption, is particularly advantageous in the present case with regard to secure and precise positioning and fixing of the sheet metal part 9 in the moulding tool 6.

In the example shown, the further Y slot is provided approximately in the centre of the transverse frame portion 13b. Alternatively, the further slot 15 is provided in the region of a longitudinal end 21 of the transverse frame portion 13b (see reference sign 15′).

The sheet metal part 9 enables the advantages and functions mentioned above.

Alternatively or in addition to the further Y slot 15, spacers 22, for example made of an elastomer, are attached to one or more of the retaining tabs 17. This is shown as an example in FIG. 9, which in turn shows a device 5 for production. The retaining tabs 17 are attached to longitudinal frame portions 12, which are oriented perpendicular to the first transverse frame portion 13. When the sheet metal part 9 is inserted into the lower tool half, the spacers 22 come into contact with a corresponding side wall 23 of the lower or upper tool half 7, 8 of the forming tool 6 opposite the spacers 22. This causes the sheet metal part 9 to be centred in the Y direction and securely positioned in the forming tool 6.

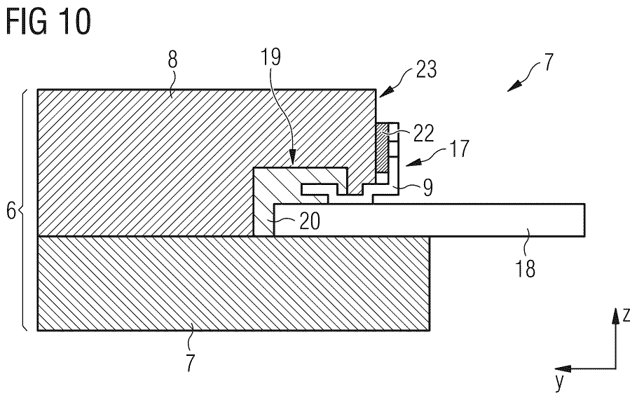

FIG. 10 shows a detailed, schematic cross sectional view of the device 5, wherein a spacer 22 can be seen, which is in direct, touching contact with the side wall 23 of the upper tool half and thus ensures secure positioning.

The one or more spacers 22 are either fixedly arranged on the sheet metal part 9, i.e. fixedly connected, and remain on the sheet metal part 9 after production of the glass element 3. Alternatively, the one or more spacers 22 are arranged on the sheet metal part 9 detachably, i.e. removably.

In an alternative exemplary embodiment of the invention, not shown, one or more spacers are provided on or in the moulding tool. Analogously to above, these can be arranged fixedly mounted or detachably, i.e. removably.

### LIST OF REFERENCE SIGNS

motor vehicle
vehicle roof
glass element
fastening region
device
moulding tool
lower tool half
upper tool half
sheet metal part
9′, 9″ torsion, twisting of the sheet metal part
sheet metal frame
frame portion
longitudinal frame portion
transverse frame portion
13a, 13b transverse frame portion
X slot
Y slot
positioning pin
retaining tab
glass pane
cavity
foam surround
longitudinal end
spacer
side wall
A A sectional view

1. A sheet metal part for a glass element of a vehicle roof, wherein:
the sheet metal part is designed as a closed sheet metal frame, which is formed by four elongate frame portions, of which two frame portions are arranged opposite one another in each case,
the frame portions have two first slots and one second slot, and
the first slots are designed for positioning the sheet metal part in a moulding tool with respect to a first X direction, and the second slot is designed for positioning the sheet metal part in the moulding tool with respect to a second Y direction, which runs perpendicular to the first direction,
wherein a frame portion has a further second slot.

2. The sheet metal part according to claim 1, wherein a first frame portion of the four frame portions has the two first slots and the one second slot and a second frame portion has the further second slot.

3. The sheet metal part according to claim 2, wherein the second frame portion is opposite the first frame portion.

4. The sheet metal part according to claim 2, wherein the second frame portion is oriented perpendicular to the first frame portion.

5. The sheet metal part according to claim 2, wherein the second slot of the first frame portion is arranged between the two first slots with respect to a longitudinal direction of the first frame portion.

6. The sheet metal part according to claim 2, wherein the further second slot of the second frame portion is arranged in the region of a longitudinal end of the second frame portion.

7. A sheet metal part for a glass element of a vehicle roof, wherein
the sheet metal part is designed as a closed sheet metal frame, which is formed by four elongate frame portions, of which two frame portions are arranged opposite one another in each case,
the frame portions have two first slots and one second slot, and
the first slots are designed for positioning the sheet metal part in a moulding tool with respect to a first direction and the second slot is designed for positioning the sheet metal part in the moulding tool with respect to a second direction, which runs perpendicular to the first direction,
wherein one frame portion has at least one spacer, wherein the at least one spacer serves to position the sheet metal part in the moulding tool with respect to the second direction.

8. The sheet metal part according to claim 7, wherein the at least one spacer is made of an elastomer plastics material.

9. The sheet metal part according to claim 7, wherein a first frame portion has two first slots and one second slot, wherein the at least one spacer is arranged on a second frame portion which is oriented perpendicular to the first frame portion.

10. The sheet metal part according to claim 7, wherein the at least one spacer is arranged on a retaining tab of a frame portion.

11. A device for producing a glass element for a vehicle roof, comprising:
a moulding tool with a lower tool half and an upper tool half,
wherein the lower tool half is designed to form fittingly receive a sheet metal part according to claim 1, and
the lower tool half has three positioning pins which are arranged in such a way that the positioning pins engage form fittingly in the corresponding first slots and the second slot of the received sheet metal part,
wherein the lower tool half has a further positioning pin for engagement in the further second slot and/or a side wall of the lower or upper tool half is in direct contact with at least one spacer arranged on the sheet metal part and/or the lower or upper tool half has at least one spacer for direct contact with the sheet metal part.

12. A vehicle roof of a motor vehicle, comprising a glass element, wherein the glass element comprises a sheet metal part according to claim 1.
